(19) United States
(12) Patent Application Publication
(10) Pub. No.: US 2026/0058421 A1
(43) Pub. Date: Feb. 26, 2026

(54) CONNECTOR

(71) Applicant: Bellwether Electronic Corp., Taoyuan City (TW)

(72) Inventors: Hsing-Yu LEE, Taoyuan City (TW); Yen-Jang LIAO, Taoyuan City (TW)

(21) Appl. No.: 19/277,425

(22) Filed: Jul. 23, 2025

Related U.S. Application Data
(60) Provisional application No. 63/685,259, filed on Aug. 20, 2024.

(51) Int. Cl. H01R 25/14

(52) U.S. Cl. CPC H01R 25/142

(57) ABSTRACT

The disclosure relates to a connector including an insulating housing, two terminal sets, and two cable connection assemblies. The insulating housing has two mounting slots. The two terminal sets are respectively mounted in the two mounting slots. Each of the two terminal sets includes two outer terminal members and two inner terminal members, with the two inner terminal members located between the two outer terminal members. Each of the two inner terminal members and the two outer terminal members has a connecting portion and multiple spring arms. A gap is formed between adjacent two of the spring arms. The inner terminal members and the outer terminal members are connected to each other through their respective connecting portions. The two cable connection assemblies are respectively connected to the two terminal sets. Each cable connection assembly includes two cable connecting elements which are L-shaped.

### CROSS-REFERENCE TO RELATED APPLICATION

The application claims priority to U.S. Provisional Application Ser. No. 63/685,259, filed Aug. 20, 2024, which is herein incorporated by reference in its entirety.

### BACKGROUND

### Field of Invention

The present disclosure relates to a connector. More particularly, the present disclosure relates to a busbar clip connector.

### Description of Related Art

A busbar clip connector is a clamp-type connector specifically designed to connect cables, modules, or devices to a busbar. It is typically used in high-current applications, such as servers, distribution panels, switchgear, and industrial power systems.

### SUMMARY

The present disclosure provides a connector including an insulating housing, two terminal sets, and two cable connection assemblies. The insulating housing has two mounting slots. The two terminal sets are respectively mounted in the two mounting slots. Each of the two terminal sets includes two outer terminal members and two inner terminal members. Each of the two outer terminal members has an outer terminal connecting portion and multiple outer terminal spring arms. A gap is formed between adjacent two of the outer terminal spring arms. The two inner terminal members are located between the two outer terminal members. Each of the two inner terminal members includes an inner terminal connecting portion and multiple inner terminal spring arms. A gap is formed between adjacent two of the inner terminal spring arms. The two outer terminal members are connected to each other through the outer terminal connecting portions. The two inner terminal members are connected to each other through the inner terminal connecting portions. The two cable connection assemblies are respectively connected to the two terminal sets. Each of the two cable connection assemblies includes two cable connecting elements which are L-shaped.

The present disclosure also provides a connector including an insulating housing, two terminal sets, and two cable connection assemblies. The insulating housing has two insertion slots and two side windows. The two side windows are located on opposite sides of the insulating housing. The two terminal sets are respectively mounted in the two insertion slots. The two cable connection assemblies are respectively connected to the two terminal sets. Each of the two cable connection assemblies includes a first cable connecting element and a second cable connecting element which are L-shaped. The first cable connecting element extends toward one of the two side windows to connect to a cable. The second cable connecting element extends toward the other of the two side windows to connect to another cable.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of an electronic device according to one embodiment of the present disclosure;

FIG. 2 is an exploded diagram of an electronic device according to one embodiment of the present disclosure;

FIGS. 3A to 3D are schematic diagrams of an insulating housing according to one embodiment of the present disclosure;

FIG. 4 is a schematic diagram of a latch member according to one embodiment of the present disclosure;

FIGS. 5A to 5C are schematic diagrams illustrating installation procedure of an electronic device according to one embodiment of the present disclosure;

FIG. 6 is a schematic diagram of two terminal sets and two cable connection assemblies according to one embodiment of the present disclosure;

FIG. 7 is an exploded diagram of a terminal set and a cable connection assembly according to one embodiment of the present disclosure;

FIG. 8A is a schematic diagram of an outer terminal set according to one embodiment of the present disclosure;

FIG. 8B is a schematic diagram of an inner terminal set according to one embodiment of the present disclosure;

FIG. 8C is a schematic diagram of a terminal connecting member according to one embodiment of the present disclosure;

FIG. 9 is a schematic diagram of two terminal sets according to one embodiment of the present disclosure;

FIG. 10 is a schematic diagram of a terminal set, a cable connection assembly, and a cable set according to one embodiment of the present disclosure;

FIG. 11 is a schematic diagram of partial components of an electronic device according to one embodiment of the present disclosure;

FIG. 12 is a schematic diagram of an electronic device according to another embodiment of the present disclosure;

FIG. 13 is an exploded diagram of a terminal set and a cable connection assembly according to another embodiment of the present disclosure;

FIG. 14 is a schematic diagram of two cable connection assemblies according to another embodiment of the present disclosure;

FIG. 15 is a schematic diagram of an electronic device according to still another embodiment of the present disclosure; and

FIG. 16 is a schematic diagram of a connector according to still another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following disclosure provides numerous different embodiments or examples for implementing various features of the disclosed subject matter. Specific examples of components and arrangements are described below to simplify the present disclosure. These examples are, of course, merely illustrative and are not intended to be limiting. In addition, reference numerals and/or letters may be repeated throughout the disclosure for the sake of simplicity and clarity. Such repetition does not in itself indicate a relationship between the various embodiments and/or configurations discussed.

In order to clearly illustrate the positional and relational orientation among the various components, coordinate axes are indicated in the drawings, namely a first axis direction A1, a second axis direction A2, and a third axis direction A3.

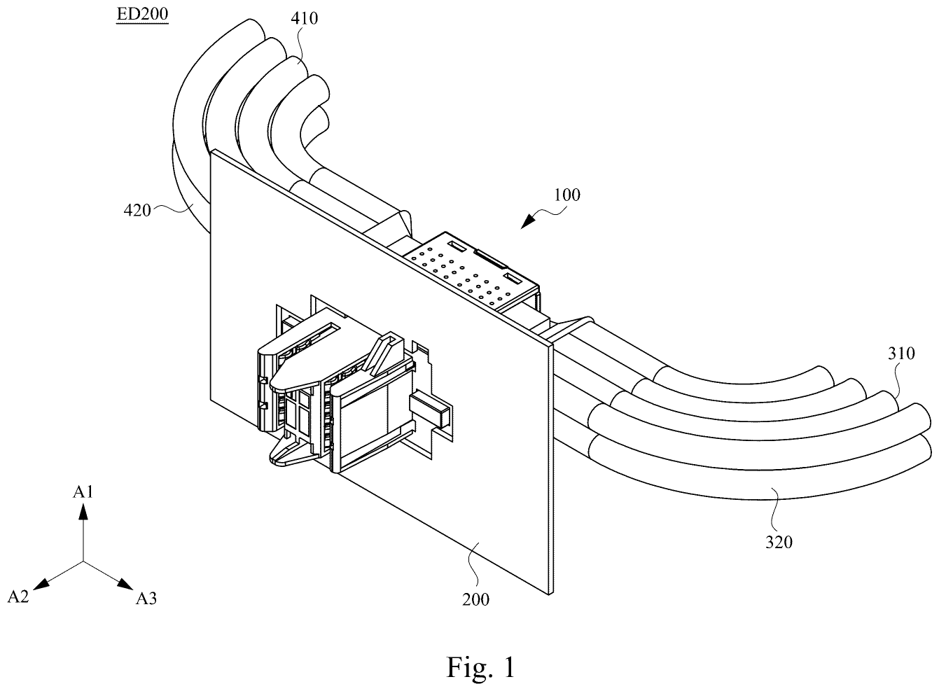

Please refer to FIG. 1, which is a schematic diagram of an electronic device ED200 according to the present disclosure. The electronic device ED200 provided by the present disclosure may be any device that requires a connector to electrically connect cables to a busbar. In FIG. 1, the electronic device ED200 includes a connector 100, a first left cable set 310, a second left cable set 320, a first right cable set 410, and a second right cable set 420. The connector 100 is configured to be mounted to a panel 200 for mating with the busbar, and the connector 100 is floatable relative to the panel 200. The first left cable set 310 and the second left cable set 320 are respectively connected to a left side of the connector 100, and the first right cable set 410 and the second right cable set 420 are respectively connected to a right side of the connector 100.

In some embodiments, the connector 100 is a busbar clip connector, which may be applied, for example, as a busbar connection device for connecting to a busbar in a server chassis. The connector 100 provided by the present disclosure is capable of connecting to multiple cable sets.

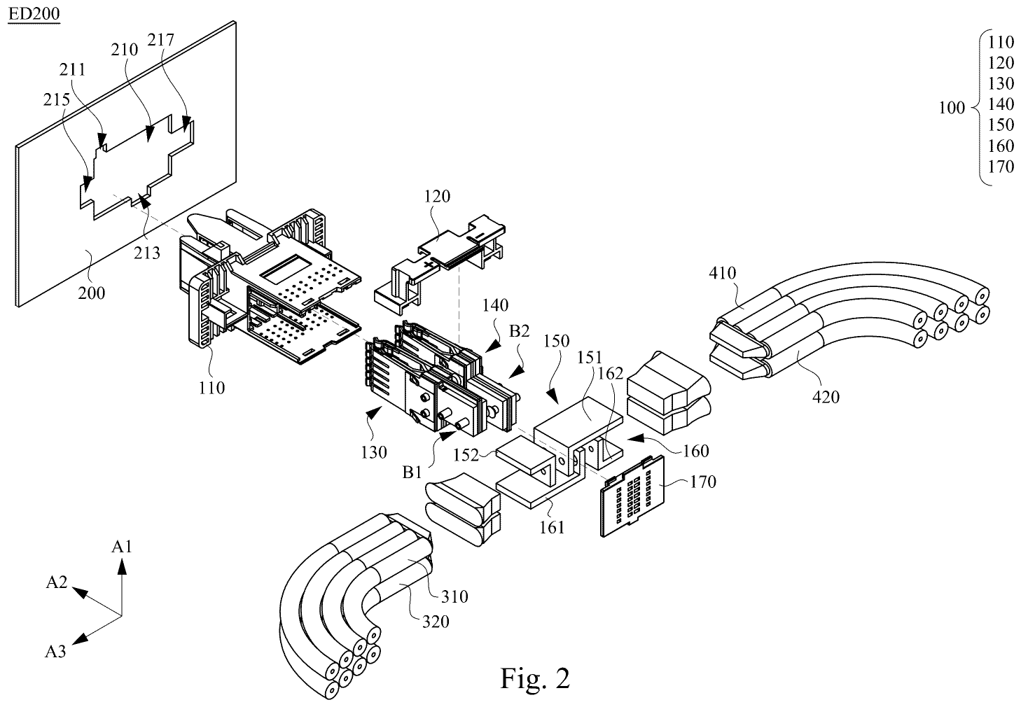

Please refer to FIG. 2, which is an exploded diagram of the electronic device ED200 according to one embodiment of the present disclosure. The connector 100 includes an insulating housing 110, a latch member 120, a first terminal set 130, a second terminal set 140, a first cable connection assembly 150, a second cable connection assembly 160, and a cover member 170.

In FIGS. 1 and 2, the latch member 120 is connected to the insulating housing 110 and is slidable relative to the insulating housing 110. The first terminal set 130 and the second terminal set 140 are electrically connected to different voltages and are respectively assembled in the insulating housing 110. The first cable connection assembly 150 is connected to the first terminal set 130. The second cable connection assembly 160 is connected to the second terminal set 140. The first left cable set 310 and the first right cable set 410 are electrically connected to the first terminal set 130 through the first cable connection assembly 150. The second left cable set 320 and the second right cable set 420 are electrically connected to the second terminal set 140 through the second cable connection assembly 160. The cover member 170 is connected to the insulating housing 110 so as to shield and protect the first terminal set 130, the second terminal set 140, the first cable connection assembly 150, and the second cable connection assembly 160 that are assembled in the insulating housing 110.

The panel 200 is located within a system or chassis and includes a through opening 210. In some embodiments, the panel 200 includes a first limiting hole 211, a second limiting hole 213, a third limiting hole 215, and a fourth limiting hole 217, which are connected to and located around the opening 210. The first limiting hole 211 and the second limiting hole 213 are located on opposite sides (i.e., upper and lower sides) of the opening 210 for alignment when assembling the insulating housing 110. The third limiting hole 215 and the fourth limiting hole 217 are located on other opposite sides (i.e., left and right sides) of the opening 210 and are configured to work together with the latch member 120 to constrain the movement of the insulating housing 110. The number and positions of the limiting holes described above are not intended to be limiting to the present disclosure.

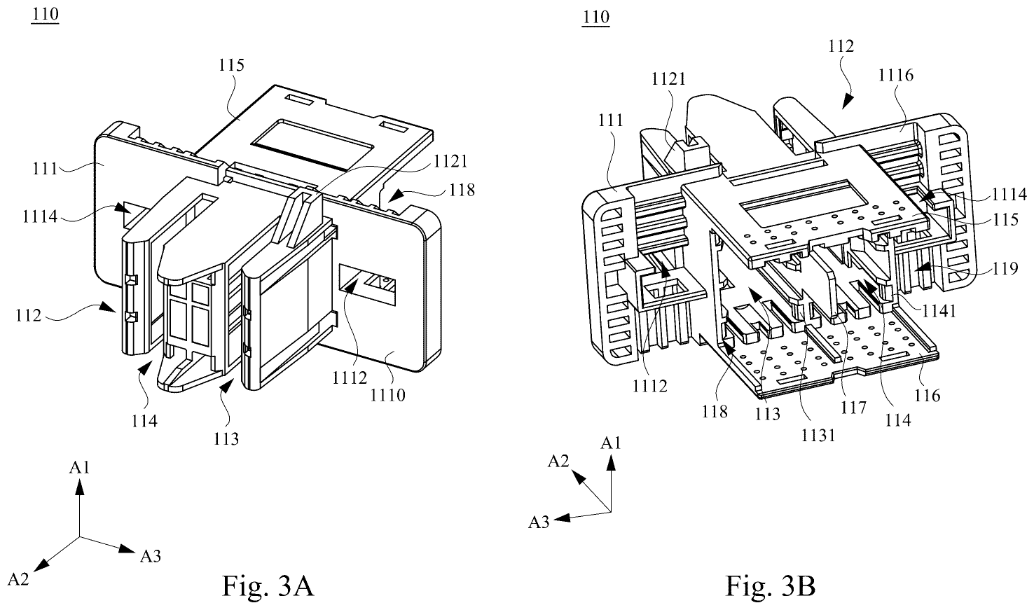

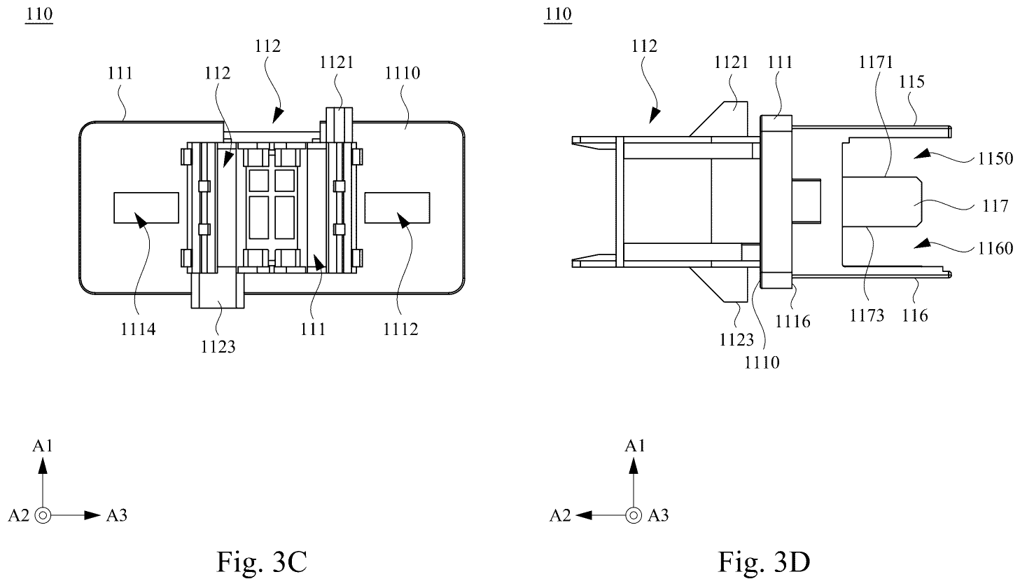

Please refer to FIGS. 3A to 3D. FIGS. 3A and 3B are schematic diagrams of the insulating housing 110 from different perspectives. FIG. 3C is a front view of the insulating housing 110. FIG. 3D is a side view of the insulating housing 110. In some embodiments, the insulating housing 110 includes a main body portion 111, a contact portion 112, a first mounting slot 113, a second mounting slot 114, a first side wall 115, a second side wall 116, and a partition wall 117. A first side window 118 and a second side window 119 are located on opposite sides of the insulating housing 110, while the first mounting slot 113 and the second mounting slot 114 are located on another side.

Please refer to FIG. 3A. The main body portion 111 has an abutting surface 1110 configured to abut against the panel 200, and a first opening 1112 and a second opening 1114 that pass through the abutting surface 1110. When the connector 100 is mounted to the panel 200, the first opening 1112 and the second opening 1114 respectively correspond to the third limiting hole 215 and the fourth limiting hole 217 of the panel 200 (see also FIG. 2). The contact portion 112 extends from the abutting surface 1110 away from the main body portion 111.

Please refer to FIG. 3B. The first mounting slot 113 and the second mounting slot 114 are grooves that pass through the main body portion 111 and the contact portion 112 along the second axis direction A2, and form two insertion slots in the contact portion 112. The partition wall 117 is located between the first mounting slot 113 and the second mounting slot 114 to separate the two slots. The first mounting slot 113 is adjacent to the first opening 1112, and the second mounting slot 114 is adjacent to the second opening 1114. The first terminal set 130 is mounted in the first mounting slot 113. The second terminal set 140 is mounted in the second mounting slot 114.

The main body portion 111 has a rear surface 1116 opposite to the abutting surface 1110. The first side wall 115 and the second side wall 116 are parallel to each other and extend from the rear surface 1116 away from the main body portion 111. The first side wall 115 and the second side wall 116 are respectively located on opposite sides (i.e., upper and lower sides) of the rear surface 1116. The first side window 118 is located between the first side wall 115 and the second side wall 116 and is adjacent to the first opening 1112. The second side window 119 is located between the first side wall 115 and the second side wall 116 and is adjacent to the second opening 1114.

The first mounting slot 113 includes a protrusion 1131 located within the slot channel. The protrusion 1131 is used to engage and secure the first terminal set 130. As shown in FIG. 3B, the protrusion 1131 is located at the lower right corner of the first mounting slot 113. In some embodiments, the first mounting slot 113 may include multiple protrusions 1131. For example, additional protrusions may be provided at the upper right corner, the lower left corner, and the upper left corner of the first mounting slot 113 (not shown in the figure). The second mounting slot 114 includes a protrusion 1141 located within the slot channel, and the configuration of the protrusion 1141 is similar to that of the protrusion 1131.

Please refer to FIG. 3C. The contact portion 112 further includes a first engaging rib 1121 and a second engaging rib 1123, respectively located on opposite outer sides of the contact portion 112 (i.e., upper and lower sides). When the connector 100 is inserted into the opening 210 of the panel 200, the first engaging rib 1121 and the second engaging rib 1123 respectively correspond to (align with) the first limiting hole 211 and the second limiting hole 213 of the panel 200.

Please refer to FIG. 3D. As shown in the figure, a first passage 1150 is formed between the first side wall 115 and an upper side 1171 of the partition wall 117, and a second passage 1160 is formed between the second side wall 116 and a lower side 1173 of the partition wall 117. The first cable connection assembly 150 passes through the first passage 1150, and the second cable connection assembly 160 passes through the second passage 1160. The partition wall 117 separates the first cable connection assembly 150 and the second cable connection assembly 160 along the third axis direction A3 to maintain electrical isolation therebetween (see also FIG. 2).

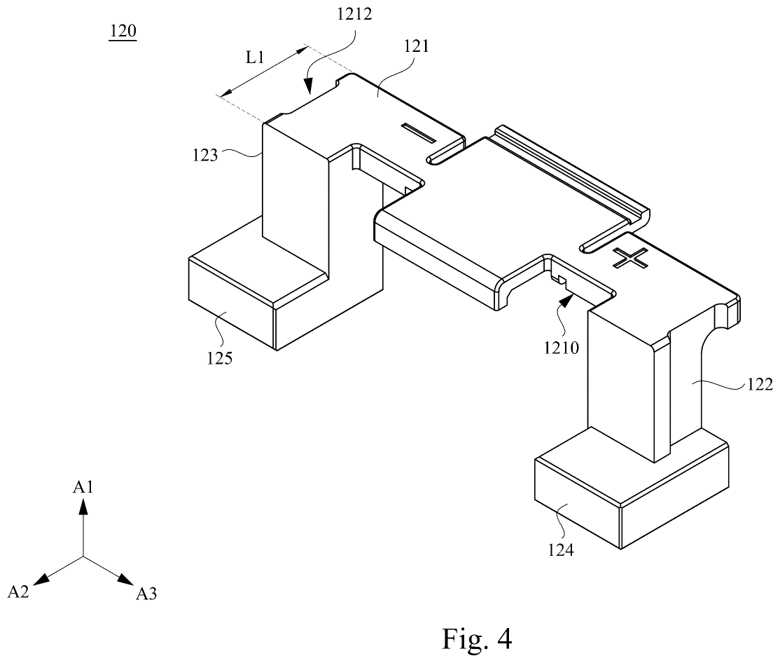

Please refer to FIG. 4, which illustrates a schematic diagram of the latch member 120. In some embodiments, the latch member 120 includes a main body portion 121, a first extension portion 122, a second extension portion 123, a first engaging portion 124, and a second engaging portion 125. The first extension portion 122 and the second extension portion 123 are respectively located on opposite sides of the main body portion 121 and extend in the same direction away from the main body portion 121. The main body portion 121, the first extension portion 122, and the second extension portion 123 together form a U-shaped structure.

The first engaging portion 124 and the second engaging portion 125 are respectively located at the ends of the first extension portion 122 and the second extension portion 123 that are away from the main body portion 121. The first engaging portion 124 and the second engaging portion 125 are configured to respectively pass through the first opening 1112 and the second opening 1114 of the insulating housing 110, and respectively align with the third limiting hole 215 and the fourth limiting hole 217 of the panel 200 when the connector 100 is mounted to the panel 200.

Please refer to FIGS. 3B and 4 together. The main body portion 121 has a surface 1210 facing the first side wall 115 of the insulating housing 110, and a short side 1212. When the latch member 120 slides relative to the insulating housing 110, the main body portion 121 slides relative to the first side wall 115 along the second axis direction A2.

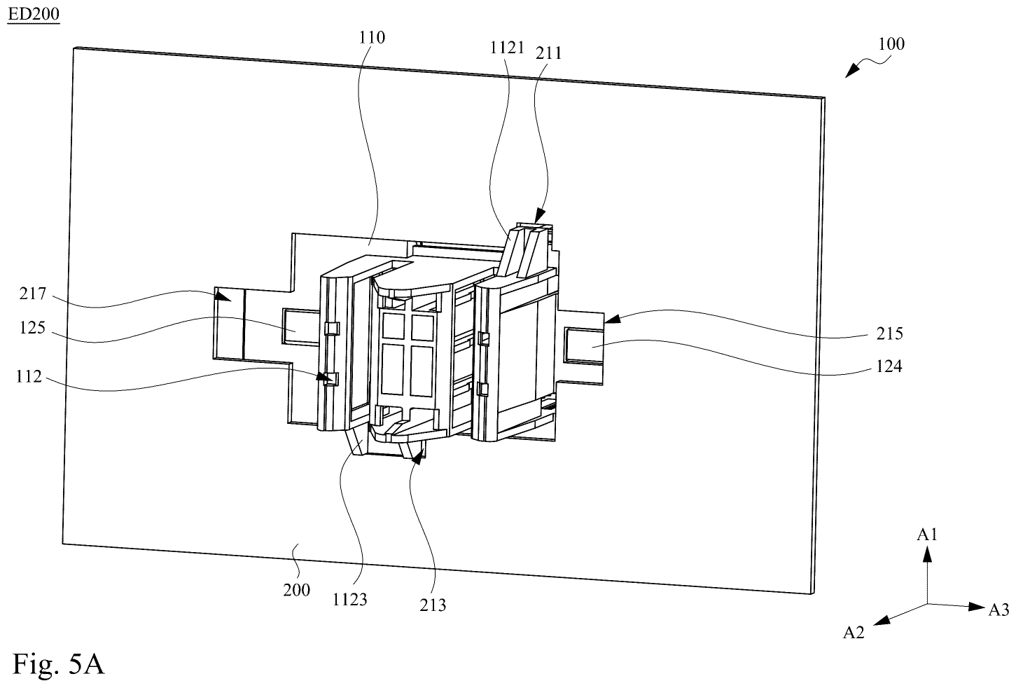

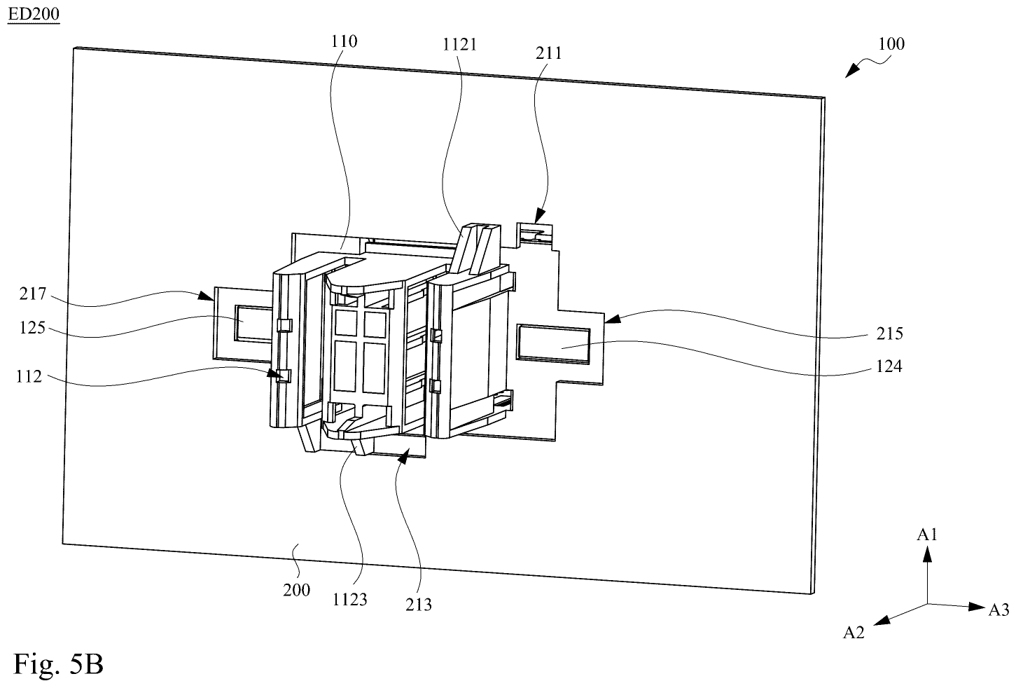

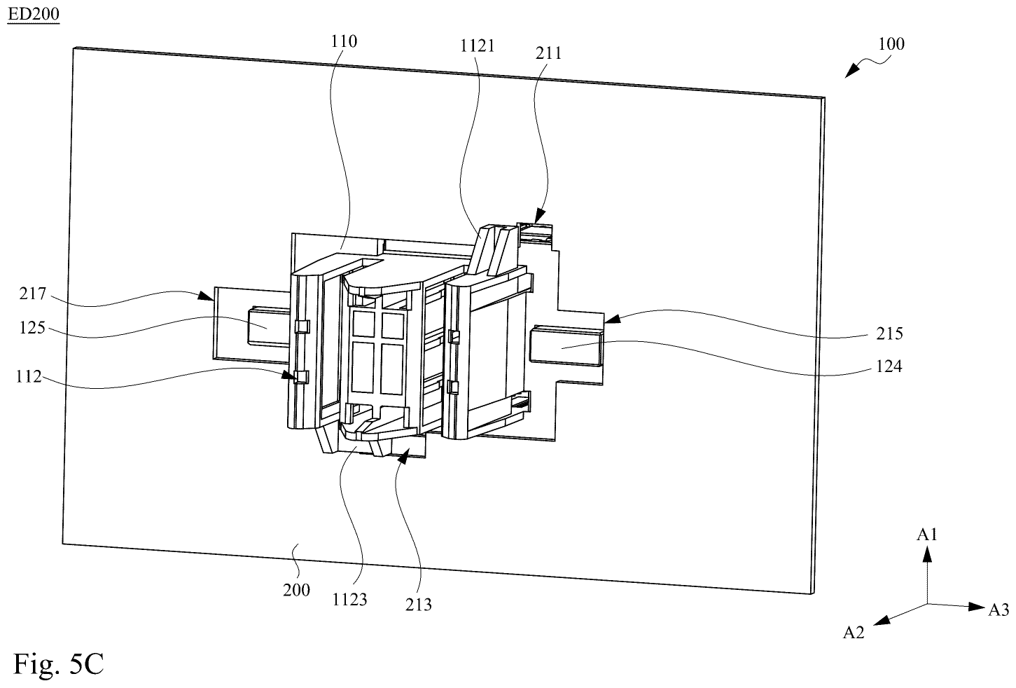

Please refer to FIGS. 5A to 5C, which respectively illustrate schematic diagrams of the steps for mounting the connector 100 to the panel 200. In FIG. 5A, the first engaging rib 1121 of the insulating housing 110 is first aligned with the first limiting hole 211 of the panel 200, and the second engaging rib 1123 of the insulating housing 110 is aligned with the second limiting hole 213 of the panel 200, such that the contact portion 112, the first engaging rib 1121, and the second engaging rib 1123 of the insulating housing 110 respectively pass through the opening 210, the first limiting hole 211, and the second limiting hole 213 of the panel 200. In some embodiments, by changing the number and/or positions of the first engaging rib 1121, the second engaging rib 1123, and the corresponding first limiting hole 211 and the second limiting hole 213, a foolproof (error-proof) mounting effect (i.e., the structure can prevent incorrect assembly) can be further achieved.

Next, as shown in FIG. 5B, the insulating housing 110 is moved along the third axis direction A3 toward the fourth limiting hole 217, such that the first engaging rib 1121 and the second engaging rib 1123 of the insulating housing 110 respectively disengage from the first limiting hole 211 and the second limiting hole 213 of the panel 200. As a result, the insulating housing 110 is prevented from being withdrawn from the panel 200 along the second axis direction A2.

Next, as shown in FIG. 5C, the latch member 120 is pushed toward the panel 200 along the second axis direction A2, such that the first engaging portion 124 and the second engaging portion 125 respectively pass through the first opening 1112 and the second opening 1114 of the insulating housing 110, and then respectively enter the third limiting hole 215 and the fourth limiting hole 217 of the panel 200. The first engaging portion 124 and the second engaging portion 125 can restrict the range of movement of the insulating housing 110 along the first axis direction A1 and the third axis direction A3, thereby providing positioning and floating functions. As shown in FIG. 5C, when the insulating housing 110 is moved toward the third limiting hole 215, the first engaging portion 124 is constrained by the third limiting hole 215, thereby preventing the first engaging rib 1121 and the second engaging rib 1123 from being repositioned to align with the first limiting hole 211 and the second limiting hole 213, and thus preventing the insulating housing 110 from being separated from the panel 200.

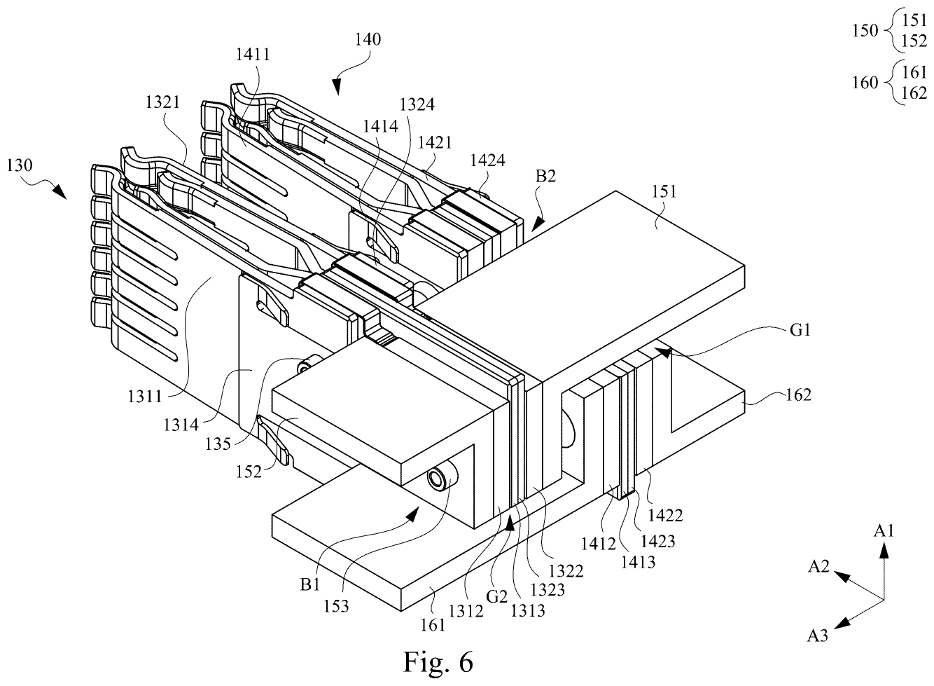

Please refer to FIG. 6, which illustrates a schematic diagram of the first terminal set 130, the second terminal set 140, the first cable connection assembly 150, and the second cable connection assembly 160.

The first terminal set 130 includes, in a stacked sequence, a first retaining member 1314, a first outer terminal member 1311, a first terminal connecting member 1312, a first inner terminal member 1313, a second inner terminal member 1323, a second terminal connecting member 1322, a second outer terminal member 1321, and a second retaining member 1324. The components of the first terminal set 130 are secured together by a fastener 135. Please also refer to FIG. 2. A rear portion of the first terminal set 130 is narrower in width than its front portion, such that a notch B1 is formed below the rear portion.

The second terminal set 140 includes, in a stacked sequence, a first retaining member 1414, a first outer terminal member 1411, a first terminal connecting member 1412, a first inner terminal member 1413, a second inner terminal member 1423, a second terminal connecting member 1422, a second outer terminal member 1421, and a second retaining member 1424. The above components of the second terminal set 140 are secured together by a fastener (not shown in the figure). Please also refer to FIG. 2. A rear portion of the second terminal set 140 is narrower in width than its front portion, such that a notch B2 is formed above the rear portion. An opening direction of the notch B2 is opposite to that of the notch B1 in the first terminal set 130. Through the opposite and offset configuration of the notch B1 and the notch B2 in the vertical direction, the second cable connection assembly 160 and the first cable connection assembly 150 can respectively extend and pass through the upper and lower spaces while avoiding physical contact with each other. This allows two cable connection assemblies to be arranged within a limited space while achieving effective electrical isolation.

The first cable connection assembly 150 includes a first cable connecting element 151 and a second cable connecting element 152. The first cable connection assembly 150 is secured to part of the components of the first terminal set 130 by a fastener 153. The second cable connection assembly 160 includes a first cable connecting element 161 and a second cable connecting element 162. The second cable connection assembly 160 is secured to part of the components of the second terminal set 140 by a fastener (not shown in the figure).

The second cable connecting element 152 and the first cable connecting element 151 are respectively connected to the left and right sides of the rear portion of the first terminal set 130, and extend away from the first terminal set 130 along the third axis direction A3. The first cable connecting element 161 and the second cable connecting element 162 are respectively connected to the left and right sides of the rear portion of the second terminal set 140, and extend away from the second terminal set 140 along the third axis direction A3. The extending portions of the first cable connecting element 151 and the second cable connecting element 152 are located on the upper side (i.e., opposite to the side where the notch B1 is formed), while the extending portions of the first cable connecting element 161 and the second cable connecting element 162 are located on the lower side (i.e., opposite to the side where the notch B2 is formed). By means of this vertically staggered configuration, two cable connection assemblies can be arranged within a limited space.

An extension length of the first cable connecting element 151 is greater than that of the second cable connecting element 152 (i.e., the lengths are unequal). The first cable connecting element 151 extends from the first terminal set 130, passes over the top through the notch B2, and spans across the rear portion of the second terminal set 140. A gap G1 is maintained between the first cable connecting element 151 and the rear end of the second terminal set 140 as well as between the first cable connecting element 151 and the second cable connection assembly 160, thereby ensuring electrical isolation between the first cable connecting element 151 and the second terminal set 140 as well as between the first cable connecting element 151 and the second cable connection assembly 160. An extension length of the first cable connecting element 161 is greater than that of the second cable connecting element 162 (i.e., the lengths are unequal). The first cable connecting element 161 extends from the second terminal set 140, passes underneath through the notch B1, and spans across the rear portion of the first terminal set 130. A gap G2 is maintained between the first cable connecting element 161 and the rear end of the first terminal set 130 as well as between the first cable connecting element 161 and the first cable connection assembly 150, thereby ensuring electrical isolation between the first cable connecting element 161 and the first terminal set 130 as well as between the first cable connecting element 161 and the first cable connection assembly 150. The extension lengths of the first cable connecting elements 151 and 161 are equal, and the extension lengths of the second cable connecting elements 152 and 162 are also equal. Furthermore, the outer surface of the first cable connecting element 151 is substantially aligned with the second cable connecting element 162 in the first axis direction A1, and the outer surface of the first cable connecting element 161 is substantially aligned with the second cable connecting element 152 in the first axis direction A1.

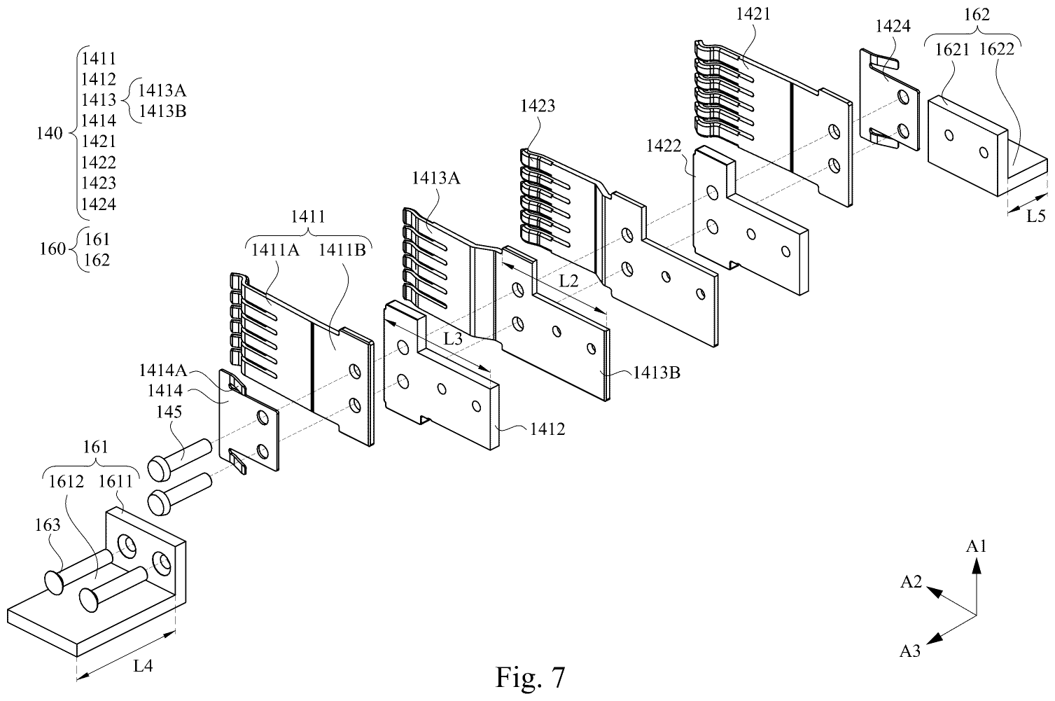

Please refer to FIG. 7, which is an exploded diagram of the second terminal set 140 and the second cable connection assembly 160.

The first inner terminal member 1413 and the second inner terminal member 1423 are located between the first outer terminal member 1411 and the second outer terminal member 1421, and are respectively connected to the first outer terminal member 1411 and the second outer terminal member 1421 through the first terminal connecting member 1412 and the second terminal connecting member 1422. This configuration allows the current flowing through the inner terminal members and the outer terminal members to be more evenly distributed (in other words, the current passing through the inner terminal members is closed to the current passing through the outer terminal members, which means the current passing through the terminal set is more evenly distributed between the inner terminal members and the outer terminal members).

The first outer terminal member 1411 includes a first outer terminal spring arm portion 1411A and a first outer terminal connecting portion 1411B. The first inner terminal member 1413 includes a first inner terminal spring arm portion 1413A and a first inner terminal connecting portion 1413B. The first outer terminal connecting portion 1411B and the first inner terminal connecting portion 1413B are respectively connected to opposite sides of the first terminal connecting member 1412. The second outer terminal member 1421 and the second inner terminal member 1423 also include spring arm portions and connecting portions, and are configured in the same manner as described above.

The first retaining member 1414 and the second retaining member 1424 are respectively located on the outer sides of the first outer terminal member 1411 and the second outer terminal member 1421. The first retaining member 1414 includes a spring arm 1414A extending away from the first outer terminal member 1411. In the assembled state as shown in FIG. 1, the spring arm 1414A abuts against the protrusion 1141 inside the second mounting slot 114, thereby preventing the second terminal set 140 from moving out of the insulating housing 110 along the second axis direction A2 (see also FIG. 3B). The second retaining member 1424 also includes a spring arm and is configured in the same manner as described above.

The components of the second terminal set 140 are secured by a fastener 145. Specifically, the fastener 145 sequentially passes through the first retaining member 1414, the first outer terminal member 1411, the first terminal connecting member 1412, the first inner terminal member 1413, the second inner terminal member 1423, the second terminal connecting member 1422, the second outer terminal member 1421, and the second retaining member 1424 to secure them together. The components and configuration of the first terminal set 130 are the same as those of the second terminal set 140.

The first cable connecting element 161 includes a fixing portion 1611 and an extension portion 1612. The fixing portion 1611 and the extension portion 1612 are plate-shaped. The fixing portion 1611 is connected to the first terminal connecting member 1412. The first outer terminal member 1411 and the first cable connecting element 161 are located on the same side of the first terminal connecting member 1412. The extension portion 1612 is configured to be connected to the second left cable set 320 (see also FIG. 2). The extension portion 1612 is connected to and perpendicular to the fixing portion 1611. The fixing portion 1611 and the extension portion 1612 together form an L-shaped structure.

The second cable connecting element 162 has a fixing portion 1621 and an extension portion 1622. The fixing portion 1621 and the extension portion 1622 are plate-shaped. The fixing portion 1621 is connected to the second terminal connecting member 1422. The second outer terminal member 1421 and the second cable connecting element 162 are located on the same side of the second terminal connecting member 1422. The extension portion 1622 is configured to be connected to the second right cable set 420 (see also FIG. 2). The extension portion 1622 is connected to and perpendicular to the fixing portion 1621. The fixing portion 1621 and the extension portion 1622 together form an L-shaped structure.

In some embodiments, the first cable connecting element 161 and the second cable connecting element 162 may be integrally formed as a single structure, thereby forming a T-shaped cable connecting element. In some embodiments, the first terminal set 130 may be disposed on one side of the fixing portion (corresponding to the fixing portion 1611 and/or 1621) of the T-shaped cable connecting element. In some embodiments, the T-shaped cable connecting element may be disposed between the terminals of the first terminal set 130. In some embodiments, the T-shaped cable connecting element may also be integrally formed with the first terminal connecting member 1412 and/or the second terminal connecting member 1422, and in some of the embodiments, the first terminal connecting member 1412 or the second terminal connecting member 1422 may be omitted.

The extension portion 1612 and the extension portion 1622 are adjacent to the second side wall 116. That is, the extension portions of the first cable connection assembly 150 connected to the first terminal set 130 are located on the same side (adjacent to the first side wall 115), while the extension portions of the second cable connection assembly 160 connected to the second terminal set 140 are located on another side (adjacent to the second side wall 116). The extension portion 1612 has a length L4 in its extending direction (i.e., the third axial direction A3), and the extension portion 1622 has a length L5 in its extending direction (i.e., the third axial direction A3), and the length L4 is greater than the length L5.

A fastener 163 sequentially passes through the first cable connecting element 161, the first terminal connecting member 1412, the first inner terminal member 1413, the second inner terminal member 1423, the second terminal connecting member 1422, and the second cable connecting element 162 to secure them together and electrically connect them to each other. The components and configuration of the first cable connection assembly 150 are the same as those of the second cable connection assembly 160.

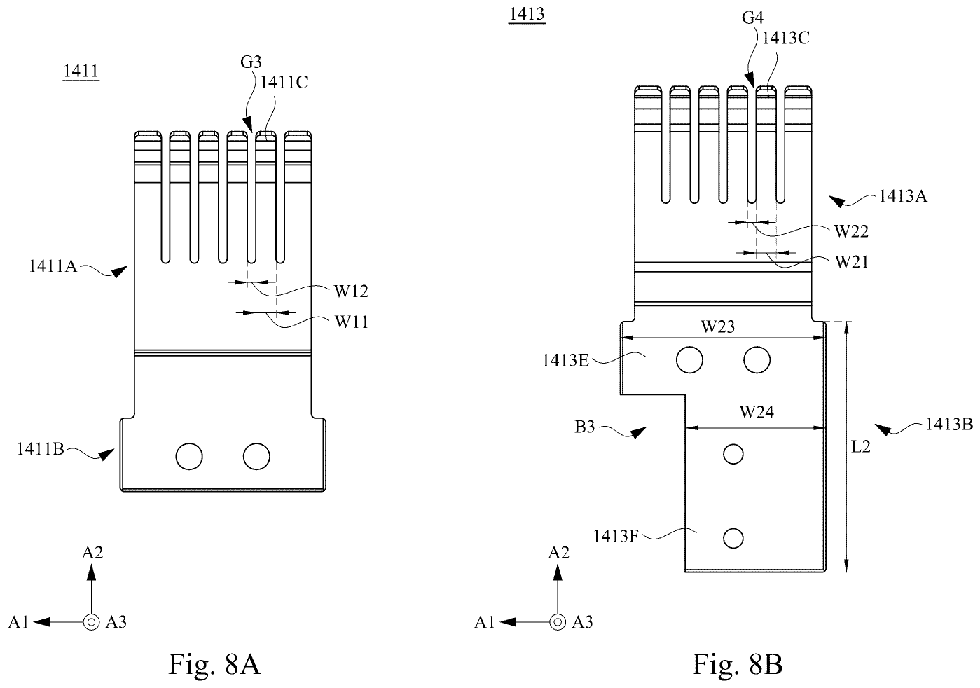

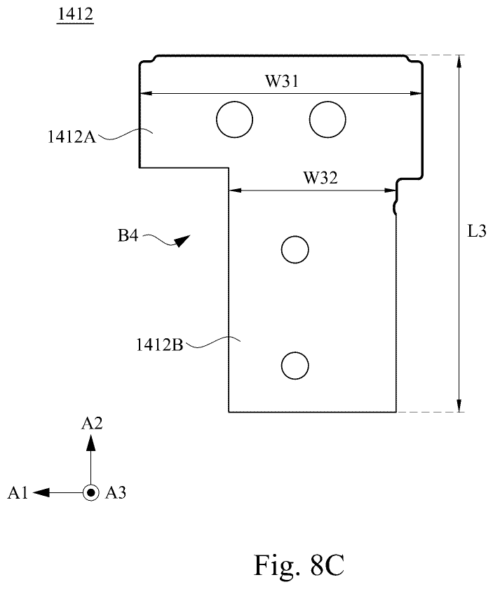

Please refer to FIGS. 8A, 8B, and 8C, which are side views of the first outer terminal member 1411, the first inner terminal member 1413, and the first terminal connecting member 1412, respectively.

In FIG. 8A, the first outer terminal spring arm portion 1411A includes multiple first outer terminal spring arms 1411C. These first outer terminal spring arms 1411C have a width W11 in their arrangement direction (i.e., the first axial direction A1). A gap G3 is formed between adjacent first outer terminal spring arms 1411C. The gap G3 has a width W12 in the arrangement direction of the first outer terminal spring arms 1411C (i.e., the first axial direction A1). A ratio of the width W11 to the width W12 is greater than 1. In other words, the combined width of the first outer terminal spring arms 1411C accounts for more than 50% of the total width of the first outer terminal spring arm portion 1411A. In the present disclosure, the outer terminal members of the first terminal set 130 and the second terminal set 140 share the same structure; therefore, only the first outer terminal member 1411 is described herein by way of example.

In FIG. 8B, the first inner terminal spring arm portion 1413A has multiple first inner terminal spring arms 1413C. These first inner terminal spring arms 1413C have a width W21 in their arrangement direction thereof (i.e., the first axial direction A1). A gap G4 is formed between adjacent first inner terminal spring arms 1413C. The gap G4 has a width W22 in the arrangement direction of the first inner terminal spring arms 1413C (i.e., the first axial direction A1). A ratio of the width W21 to the width W22 is greater than 1. In other words, the combined width of the first inner terminal spring arms 1413C accounts for more than 50% of the total width of the first inner terminal spring arm portion 1413A.

In some embodiments, the width of the terminal spring arms along the first axial direction A1 accounts for more than 70% of the total width of the terminal spring arm portion. Considering both the inner and outer terminals as a whole, a combined coverage of 70%×2=140% can be achieved, thereby increasing the total contact area between the connector terminals and an external busbar. In addition, by employing a dual-row design of inner and outer terminals, the overall contact area between each row of the terminals and the external busbar is decreased when the busbar is inserted, which can facilitate smoother insertion and removal.

As shown in FIG. 8B, the first inner terminal connecting portion 1413B further includes a front segment 1413E adjacent to the first inner terminal spring arm portion 1413A, and a rear segment 1413F away from the first inner terminal spring arm portion 1413A. The front segment 1413E and the rear segment 1413F respectively have a width W23 and a width W24 in the first axial direction A1. The width W23 is greater than the width W24, thereby a notch B3 is formed on one side of the first inner terminal connecting portion 1413B. The notch B3 is configured to allow the first cable connecting element 151 to pass therethrough (see also FIG. 6). The inner terminal components of the first terminal set 130 and the second terminal set 140 have the same structure. The width W23 of the front segment 1413E is also slightly greater than the width of the first inner terminal spring arm portion 1413A, such that it protrudes beyond both sides of the first inner terminal spring arm portion 1413A in the first axial direction A1. Accordingly, when the first terminal set 130 is installed in the first mounting slot 113, the front segment 1413E may be positioned within the positioning grooves formed on the inner surfaces of the first side wall 115 and the second side wall 116 to restrict the movement of the first terminal set 130 in the third axial direction A3.

As shown in FIG. 8C, the first terminal connecting member 1412 includes a front segment 1412A and a rear segment 1412B. The front segment 1412A corresponds to the front segment 1413E of the first inner terminal connecting portion 1413B, and the rear segment 1412B corresponds to the rear segment 1413F of the first inner terminal connecting portion 1413B. The front segment 1412A and the rear segment 1412B respectively have a width W31 and a width W32 in the first axial direction A1. The width W31 is greater than the width W32, such that a notch B4 is formed on one side of the first terminal connecting member 1412. The notch B4 is configured to allow the first cable connecting element 151 to pass therethrough (see also FIG. 6). The terminal connection members of the first terminal set 130 and the second terminal set 140 have the same structural configuration.

More specifically, the first outer terminal connecting portion 1411B is connected to the front segment 1412A of the first terminal connecting member 1412, and the fixing portion 1611 of the first cable connecting element 161 is connected to the rear segment 1412B of the first terminal connecting member 1412. The fastener 145 passes through the first outer terminal connecting portion 1411B, the front segment 1412A of the first terminal connecting member 1412, and the front segment 1413E of the first inner terminal connecting portion 1413B. The fastener 163 passes through the rear segment 1412B of the first terminal connecting member 1412 and the rear segment 1413F of the first inner terminal connecting portion 1413B.

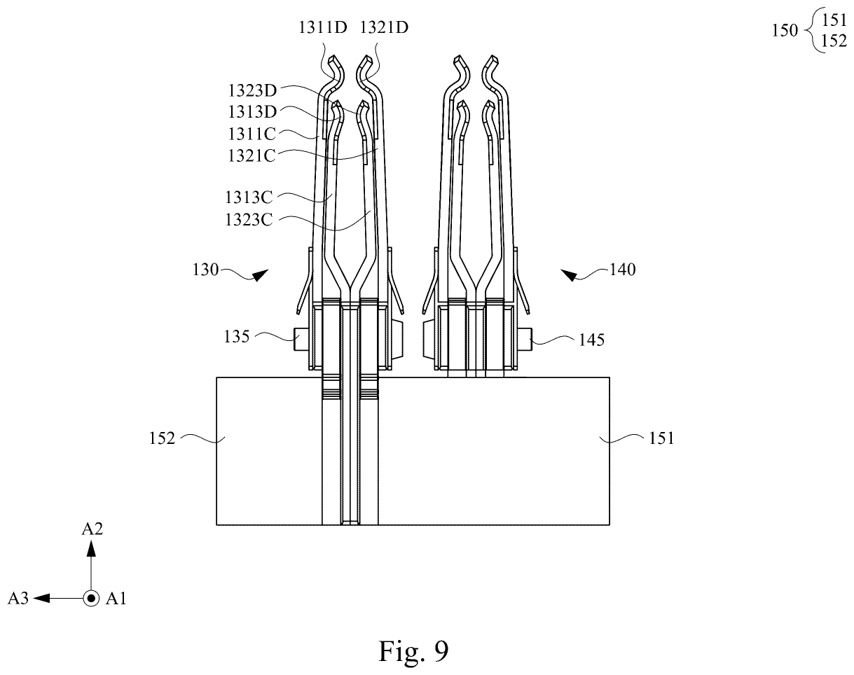

Please refer to FIG. 9, which is a top view of the first terminal set 130 and the second terminal set 140. The first outer terminal spring arms 1311C, the first inner terminal spring arms 1313C, the second outer terminal spring arms 1321C, and the second inner terminal spring arms 1323C of the first terminal set 130 respectively have a first outer terminal contact region 1311D, a first inner terminal contact region 1313D, a second outer terminal contact region 1321D, and a second inner terminal contact region 1323D at the end away from the first cable connection assembly 150. These contact regions are configured to contact a busbar. The first outer terminal contact region 1311D and the second outer terminal contact region 1321D are located on the outer sides of the first inner terminal contact region 1313D and the second inner terminal contact region 1323D. Accordingly, when a busbar is inserted into the first terminal set 130, it first contacts the first outer terminal contact region 1311D and the second outer terminal contact region 1321D, and then contacts the first inner terminal contact region 1313D and the second inner terminal contact region 1323D.

Since the first terminal set 130 includes a set of inner terminals (i.e., the first inner terminal member 1313 and the second inner terminal member 1323) and a set of outer terminals (i.e., the first outer terminal member 1311 and the second outer terminal member 1321), thereby it provides at least four contact regions for contacting with terminals of the busbar. This configuration increases the total contact area and thus enables the terminal set to conduct a higher total current. The components and configuration of the second terminal set 140 are the same as those of the first terminal set 130.

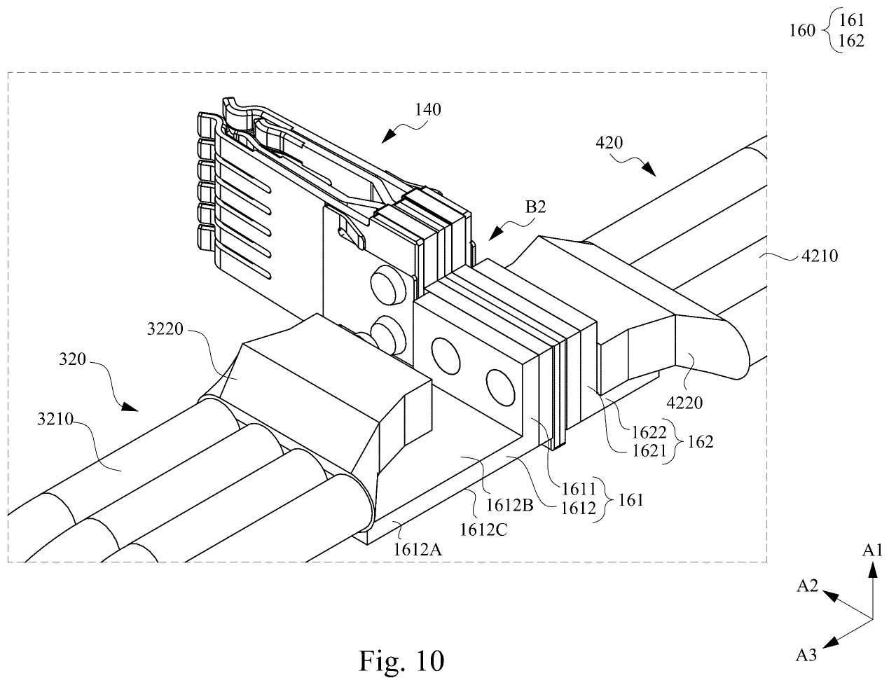

Please refer to FIG. 10, which illustrates a schematic diagram of the second terminal set 140, the second cable connection assembly 160, the second left cable set 320, and the second right cable set 420. As shown, the second left cable set 320 includes cables 3210. The number of cables 3210 is, for example but not limited to, four. These cables 3210 are ultrasonically welded to an end portion 1612A of the extension portion 1612 of the first cable connecting element 161, and are further covered and protected by an insulating layer 3220. The second right cable set 420 includes cables 4210. The number of cables 4210 is, for example but not limited to, four. These cables 4210 are ultrasonically welded to an end portion (not labeled in the figure) of the extension portion 1622 of the second cable connecting element 162, and are further covered and protected by an insulating layer 4220.

FIG. 10 illustratively depicts a state in which the cables 3210 have not yet been welded to the first cable connecting element 161. In some embodiments, the cables 3210 may be welded to the upper surface 1612B or the lower surface 1612C of the end portion 1612A of the extension portion 1612. Compared to welding on the side surface (not shown) of the end portion 1612A, it is more convenient to facilitate ultrasonic welding since the upper surface 1612B or the lower surface 1612C of the end portion 1612A can provide a larger surface area for welding. In some embodiments, the cables 3210 are welded to the upper surface 1612B, such that the cables 3210 are positioned between the first cable connecting element 161 and the second terminal set 140 along the first axis direction A1. This arrangement allows for space saving and a reduction in the total height along the first axis direction A1 among the cables 3210, the first cable connecting element 161, and the second terminal set 140.

In FIG. 10, the second terminal set 140 has the notch B2 on its upper side along the first axis direction A1, configured to allow the first cable connecting element 151 to pass through (see also FIG. 6). The notch B2 is formed by the combination of the notch B3 and the notch B4 shown in FIGS. 8B and 8C, respectively.

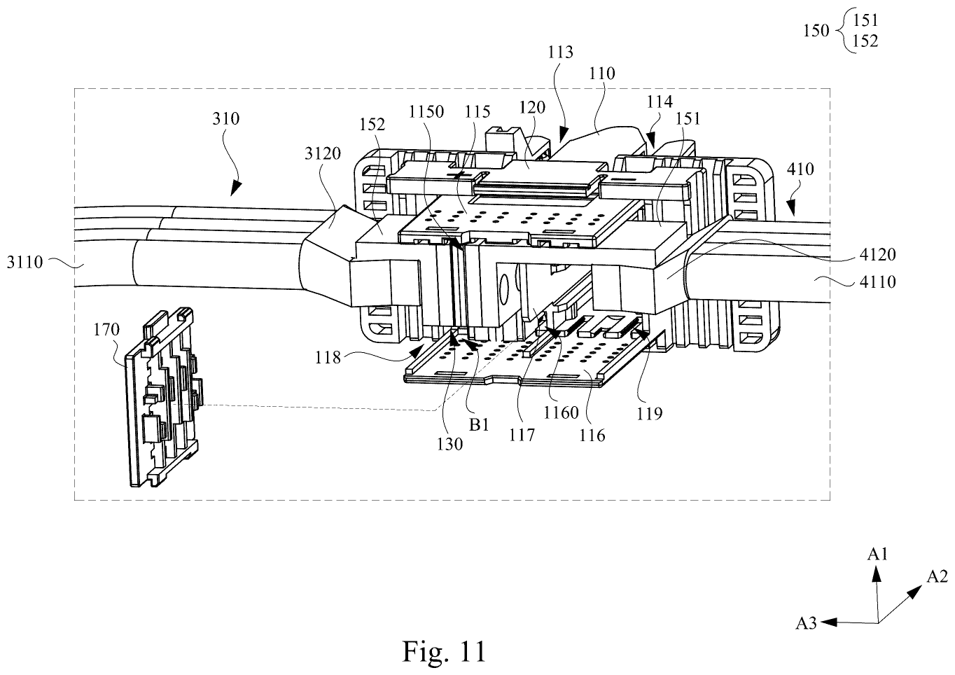

Please refer to FIG. 11, which illustrates a schematic diagram of part of the components of the connector 100, the first left cable set 310, and the first right cable set 410.

The first terminal set 130 is installed in the first mounting slot 113 of the insulating housing 110. The first cable connecting element 151 extends from one side of the first terminal set 130, passes through the first passage 1150 between the partition wall 117 and the first side wall 115, passes through the second side window 119 between the first side wall 115 and the second side wall 116, extends outside the second side window 119, and connects to the first right cable set 410. The second cable connecting element 152 extends from the other side of the first terminal set 130, passes through the first side window 118 between the first side wall 115 and the second side wall 116, extends outside the first side window 118, and connects to the first left cable set 310. The cover member 170 is configured to latch onto the first side wall 115 and the second side wall 116 to cover and protect the components installed within the insulating housing 110.

With reference to FIGS. 1 and 6, the second terminal set 140, which is not shown in FIG. 11, is installed in the second mounting slot 114 of the insulating housing 110. The first cable connecting element 161 extends from one side of the second terminal set 140, passes through the second passage 1160 between the partition wall 117 and the second side wall 116, passes through the first side window 118 between the first side wall 115 and the second side wall 116, extends outside the first side window 118, and connects to the second left cable set 320. The second cable connecting element 162 extends from the other side of the second terminal set 140, passes through the second side window 119 between the first side wall 115 and the second side wall 116, extends outside the second side window 119, and connects to the second right cable set 420.

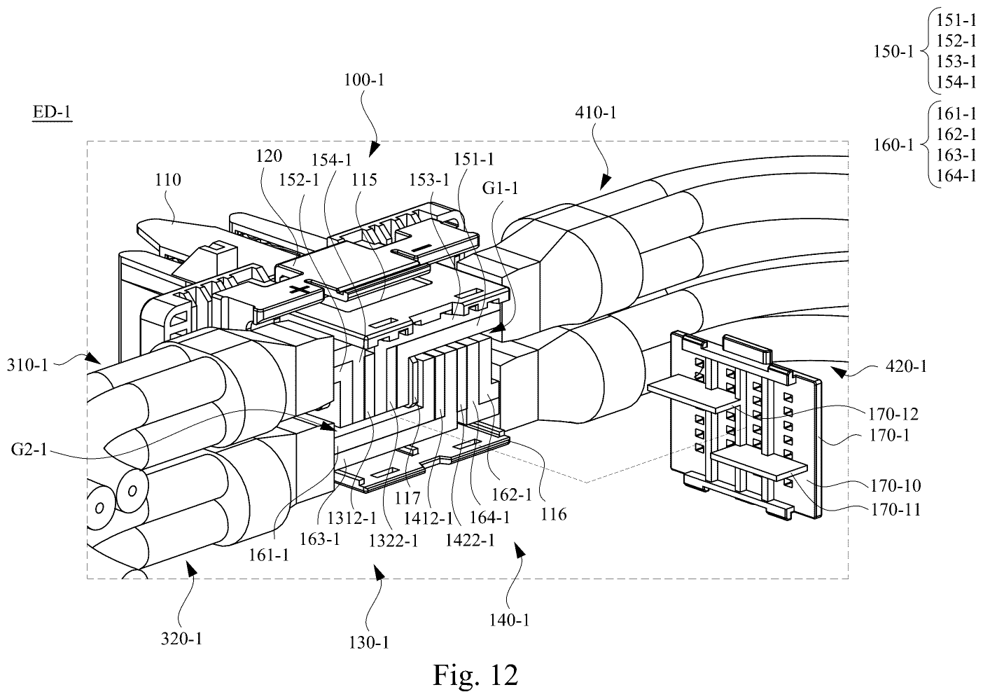

Please refer to FIG. 12, which illustrates a schematic diagram of an electronic device ED-1 according to another embodiment. The electronic device ED-1 includes a connector 100-1, a first left cable set 310-1, a first right cable set 410-1, a second left cable set 320-1, and a second right cable set 420-1. To conduct a higher total current, the cable sets in the electronic device ED-1 includes two rows of cables, as compared to the cable set having one row of cables described above. To accommodate this change in cable configuration, the terminal sets, cable connection assemblies, and the cover member in the connector 100-1 are structurally different from those in the connector 100.

In FIG. 12, the connector 100-1 includes the insulating housing 110, the latch member 120, a first terminal set 130-1, a second terminal set 140-1, a first cable connection assembly 150-1, a second cable connection assembly 160-1, and a cover member 170-1. The structures of the insulating housing 110 and the latch member 120 are the same as those described in the connector 100 and will not be described again here. The following describes the first terminal set 130-1, the second terminal set 140-1, the first cable connection assembly 150-1, the second cable connection assembly 160-1, and the cover member 170-1.

In FIG. 12, the first cable connection assembly 150-1 includes a first cable connecting element 151-1, a second cable connecting element 152-1, a third cable connecting element 153-1, and a fourth cable connecting element 154-1. The second cable connection assembly 160-1 includes a first cable connecting element 161-1, a second cable connecting element 162-1, a third cable connecting element 163-1, and a fourth cable connecting element 164-1. Compared to the connector 100, in which each cable connection assembly includes two cable connecting elements, the cable connection assemblies in the connector 100-1 include four cable connecting elements so as to conduct a higher total current.

In FIG. 12, a gap G1-1 is formed between the first cable connecting element 151-1 and the rear end of the second terminal set 140-1, as well as between the first cable connecting element 151-1 and the second cable connection assembly 160-1, so as to prevent physical contact between them. Likewise, a gap G2-1 is formed between the second cable connecting element 161-1 and the rear end of the first terminal set 130-1, as well as between the second cable connecting element 161-1 and the first cable connection assembly 150-1, so as to prevent physical contact between them.

In FIG. 12, the cover member 170-1 includes a first isolation plate 170-11 and a second isolation plate 170-12 located on a cover member inner surface 170-10. These isolation plates respectively correspond to the gap G1-1 and the gap G2-1, thereby ensuring electrical isolation between the first cable connection assembly 150-1 and the second cable connection assembly 160-1.

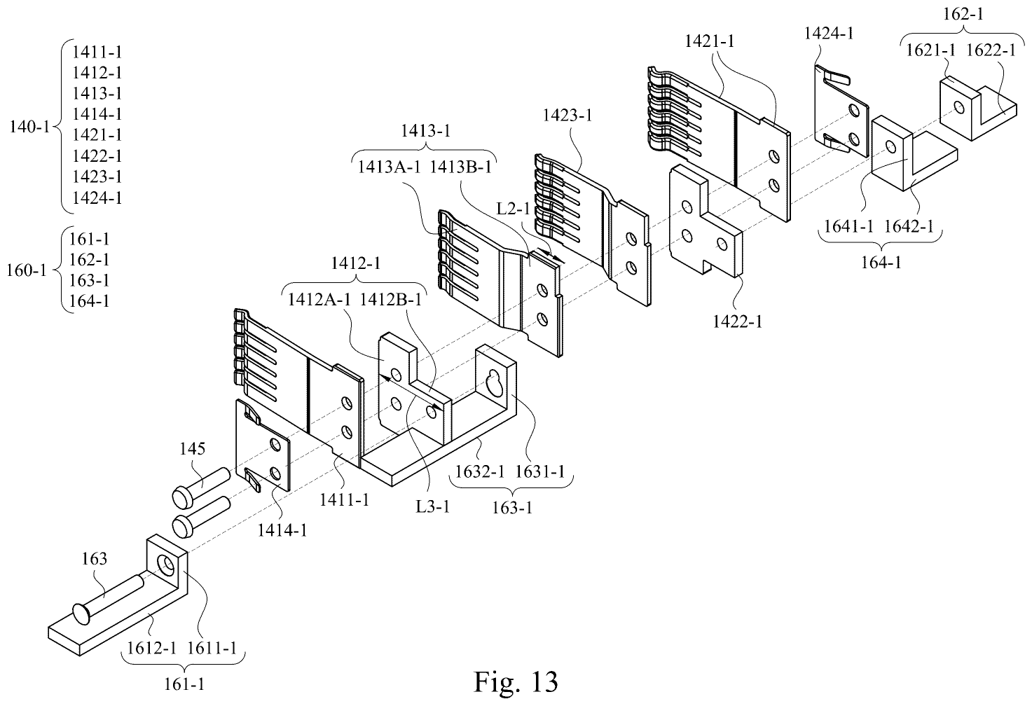

Please refer to FIG. 13, which shows an exploded view of the second terminal set 140-1 and the second cable connection assembly 160-1. The arrangement of components in the second terminal set 140-1 is similar to that of the second terminal set 140.

The components and the structure of the second terminal set 140-1 in the connector 100-1 is generally the same as those of the second terminal set 140 in the connector 100. The difference is that the first inner terminal connecting portion 1413B-1 of the first inner terminal member 1413-1 does not include the defined front segment or rear segment. A length L2-1 of the first inner terminal connecting portion 1413B-1 is shorter than the length L2 of the first inner terminal connecting portion 1413B. This change is due to the addition of more cable connecting elements in the second cable connection assembly 160-1. To accommodate spatial constraints, the overall length of the first inner terminal member 1413-1 is reduced, thereby providing more space for the additional cable connecting elements. In other words, the second cable connection assembly 160-1 is directly connected and stacked with the rear segment 1412B-1 of the first terminal connecting member 1412-1, without passing through the first inner terminal connecting portion 1413B-1, which reduces the overall stacked thickness. In the embodiment of the present disclosure, the components and arrangement of the first terminal set 130-1 are similar to those of the second terminal set 140-1.

In FIG. 13, a fixing portion 1611-1 of the first cable connecting element 161-1 and a fixing portion 1631-1 of the third cable connecting element 163-1 are respectively connected to opposite sides of the rear segment 1412B-1 of the first terminal connecting member 1412-1. The extension portion 1612-1 of the first cable connecting element 161-1 and the extension portion 1632-1 of the third cable connecting element 163-1 are in contact with each other and extend in the same direction. The outer surfaces of the extension portions 1612-1 and 1632-1 can be connected to the upper and lower rows of cables of the second left cable set 320-1, respectively (see also FIG. 12). Since the length L2-1 of the first inner terminal connecting portion 1413B-1 is shorter, space is made available for accommodating the fixing portion 1631-1 of the third cable connecting element 163-1. With this arrangement, the upper-row cables of the second left cable set 320-1 can be ultrasonically welded to the upper surface of the extension portion 1612-1, while the lower-row cables can be ultrasonically welded to the lower surface of the extension portion 1632-1. The first cable connecting element 161-1 and the third cable connecting element 163-1 are then secured to the first terminal connecting member 1412-1. Accordingly, the second left cable set 320-1 is ultrasonically welded to both the first cable connecting element 161-1 and the third cable connecting element 163-1, which reduces contact resistance between them. In addition, this design overcomes the limitation of insufficient ultrasonic welding power, which restricts the ability to weld multiple cables simultaneously.

In FIG. 13, a fixing portion 1641-1 of the fourth cable connecting element 164-1 is located between the second terminal connecting member 1422-1 and the fixing portion 1621-1 of the second cable connecting element 162-1. The extension portion 1622-1 of the second cable connecting element 162-1 and an extension portion 1642-1 of the fourth cable connecting element 164-1 are in contact with each other and extend in the same direction. The extension portions 1622-1 and 1642-1 can be connected to the upper and lower rows of cables in the second right cable set 420-1, respectively (see also FIG. 12). The components and configuration of the first cable connection assembly 150-1 are similar to those of the second cable connection assembly 160-1.

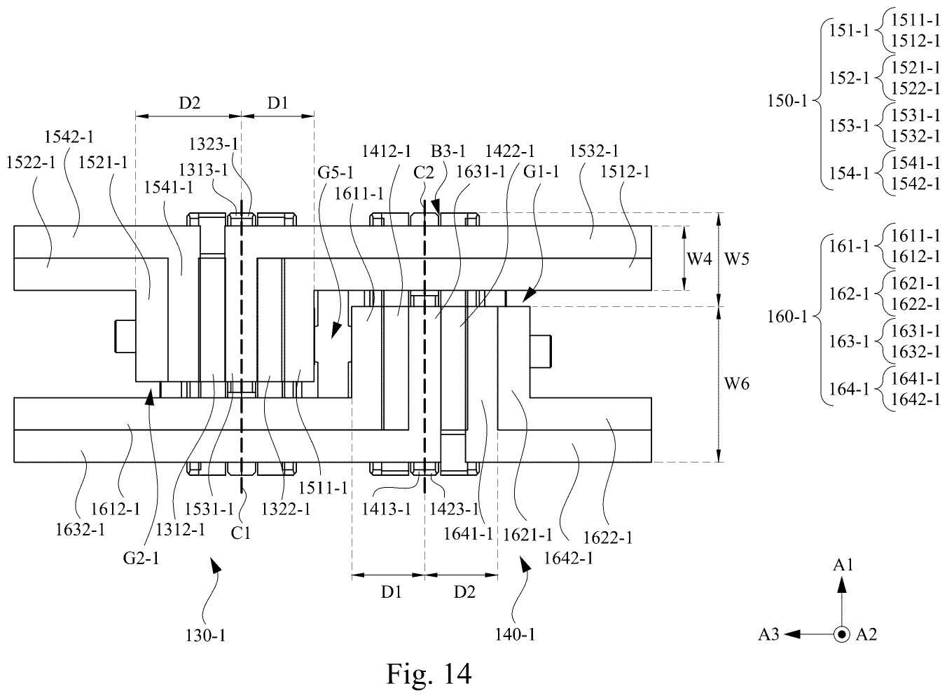

Please refer to FIG. 14, which illustrates a schematic diagram of the first cable connection assembly 150-1 and the second cable connection assembly 160-1. In FIG. 14, a contact surface between the first inner terminal member 1313-1 and the second inner terminal member 1323-1 of the first terminal set 130-1 is defined as a central axis C1 (which also serves as the center axis of the first mounting slot 113 or the corresponding slot). A distance between a surface of the fixing portion 1511-1 of the first cable connecting element 151-1 of the first cable connection assembly 150-1 (away from the first terminal set 130-1) and the central axis C1 is denoted as D1. A distance between a surface of the fixing portion 1521-1 of the second cable connecting element 152-1 of the first cable connection assembly 150-1 (away from the first terminal set 130-1) and the central axis C1 is denoted as D2. The distance D1 is shorter than the distance D2. In other words, two outer surfaces of the two fixing portions of the first cable connection assembly 150-1 are not equidistant from the central axis C1 of the first terminal set 130-1. The surface closer to the second terminal set 140-1 is positioned at a shorter distance from the central axis C1 than the surface away from the second terminal set 140-1. Since the lengths of the first inner terminal member 1313-1 and the second inner terminal member 1323-1 are reduced, the fixing portion 1531-1 of the third cable connecting element 153-1 can be positioned between the first terminal connecting member 1312-1 and the second terminal connecting member 1322-1, thereby reducing the distance D1 and allowing the first cable connection assembly 150-1 and the second cable connection assembly 160-1 to maintain a gap G5-1 between them. Accordingly, the number of cable connection assemblies can be increased while maintaining the required spacing between terminals along the third axial direction A3.

Similarly, a contact surface between the first inner terminal member 1413-1 and the second inner terminal member 1423-1 of the second terminal set 140-1 is defined as a central axis C2. A between the surface of the fixing portion 1611-1 of the first cable connecting element 161-1 of the second cable connection assembly 160-1 (away from the second terminal set 140-1) and the central axis C2 is denoted as D1. A distance between the surface of the fixing portion 1621-1 of the second cable connecting element 162-1 of the second cable connection assembly 160-1 (away from the second terminal set 140-1) and the central axis C2 is denoted as D2. The distance D1 is shorter than the distance D2.

In FIG. 14, the extension portion 1512-1 of the first cable connecting element 151-1 and the extension portion 1532-1 of the third cable connecting element 153-1 of the first cable connection assembly 150-1 have a width W4 in the first axial direction A1. The notch B3-1 formed from the top side of the second terminal set 140-1 to the top side of the second cable connection assembly 160-1 in the second axial direction A2 has a width W5. The width W4 is shorter than the width W5, thereby maintaining the gap G1-1 between the first cable connection assembly 150-1 and the rear end of the second terminal set 140-1. The fixing portion 1641-1 of the fourth cable connecting element 164-1 of the second cable connection assembly 160-1 has a width W6 in the first axial direction A1. The width W5 is shorter than the width W6. Accordingly, the fixing portion 1641-1 of the fourth cable connecting element 164-1 can have a relatively larger surface area in the plane defined by the first axial direction A1 and the second axial direction A2.

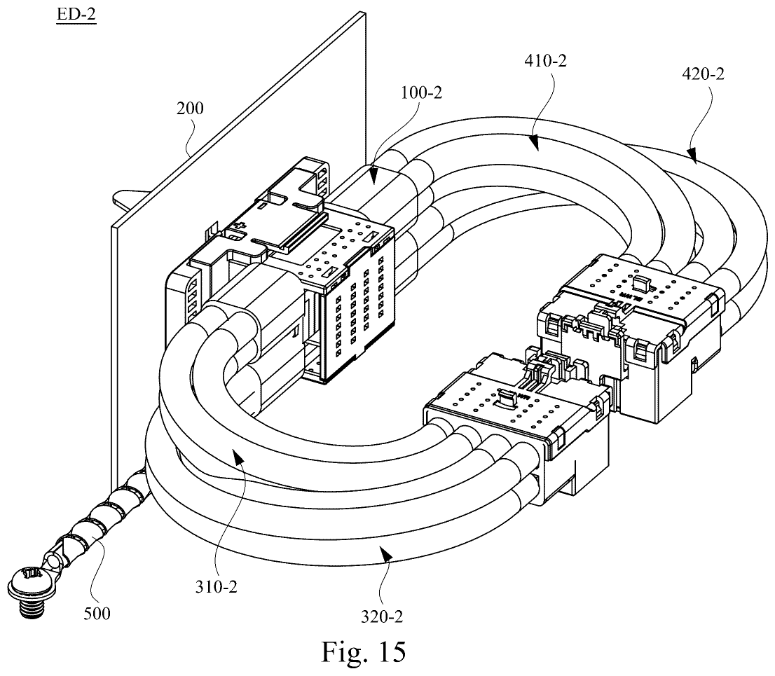

Please refer to FIG. 15, which illustrates a schematic diagram of an electronic device ED-2. The electronic device ED-2 includes a connector 100-2, a first left cable set 310-2, a first right cable set 410-2, a second left cable set 320-2, a second right cable set 420-2, and a grounding wire set 500. In order to conduct a higher total current, the electronic device ED-2 employs thicker cables in the cable sets and expands the contact area between the cable connection assemblies and the cable sets. In addition, a grounding wire set 500 is introduced. One end of the grounding wire set 500 is electrically connected to either the first terminal set 130-1 or the second terminal set 140-1 (whichever is at ground potential), while the other end is connected to the system ground. To accommodate the changed cable connection assemblies, the latch member and the cable connection assemblies in the connector 100-2 are structurally different from those in the connector 100 and/or the connector 100-1.

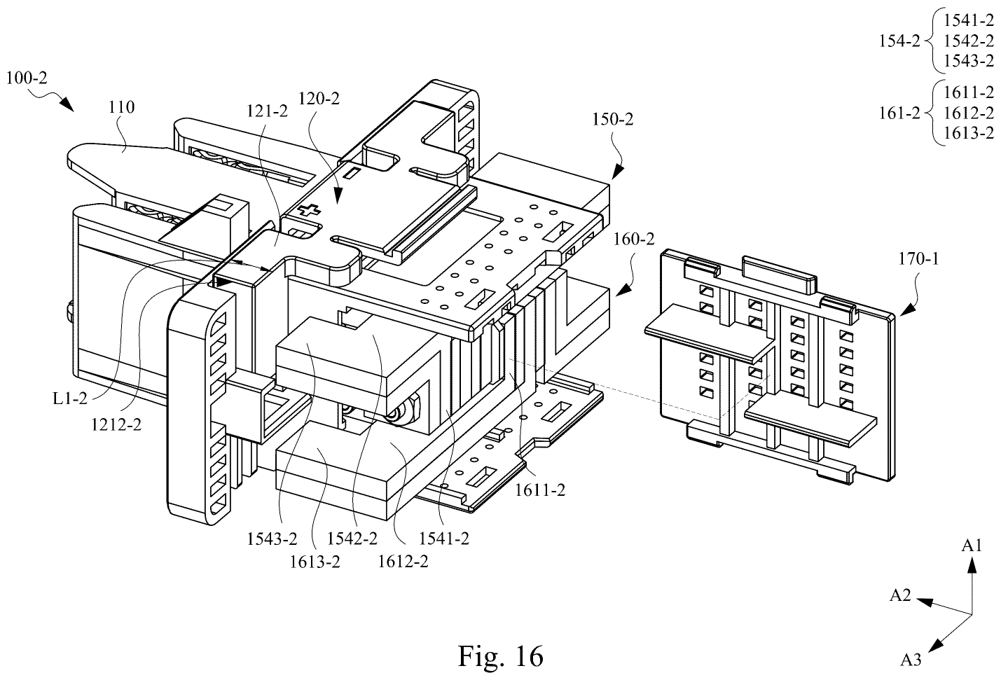

Please refer to FIG. 16, which illustrates a schematic diagram of the connector 100-2. The structure of the insulating housing 110 is the same as that described in the connector 100. The structures of the first terminal set 130-1 and the second terminal set 140-1 (not shown in the figure), as well as the structure of the cover member 170-1, are the same as those described in the connector 100-1.

Please refer to FIG. 16, as compared to the latch member 120 in FIG. 4, a length L1-2 of a short side 1212-2 of a main body portion 121-2 of the latch member 120-2 is shorter than the length L1 of the short side 1212 of the main body portion 121 of the latch member 120.

Compared to the first cable connection assembly 150 and the second cable connection assembly 160 of the connector 100, each cable connecting element of the connector 100-2 further includes an expansion portion. The following takes the fourth cable connecting element 154-2 of the first cable connection assembly 150-2 and the first cable connecting element 161-2 of the second cable connection assembly 160-2 as examples for illustration.

In FIG. 16, the fourth cable connecting element 154-2 includes a fixing portion 1541-2, an extension portion 1542-2, and an expansion portion 1543-2. The expansion portion 1543-2 extends from the extension portion 1542-2 along the second axial direction A2 toward the latch member 120-2. In other embodiments, the expansion portion 1543-2 may extend from the extension portion 1542-2 along the second axial direction A2 away from the latch member 120-2. In other embodiments, the expansion portion 1543-2 may extend from the extension portion 1542-2 along the second axial direction A2 toward the latch member 120-2 and away from the latch member 120-2. The expansion portion 1543-2 provides a larger connection area with the cable set.

In FIG. 16, the first cable connecting element 161-2 includes a fixing portion 1611-2, an extension portion 1612-2, and an expansion portion 1613-2. The expansion portion 1613-2 extends from the extension portion 1612-2 along the second axial direction A2 toward the latch member 120-2. In other embodiments, the expansion portion 1613-2 may extend from the extension portion 1612-2 along the second axial direction A2 away from the latch member 120-2. In other embodiments, the expansion portion 1613-2 may extend from the extension portion 1612-2 along the second axial direction A2 toward the latch member 120-2 and away from the latch member 120-2. The expansion portion 1613-2 is configured to provide a larger conductive contact area.

In summary, the connector disclosed herein includes an insulating housing, a latch member, two terminal sets, two cable connection assemblies, and a cover member. Through the design of the two terminal sets, the connector can simultaneously connect to both the positive and negative terminals of a power source. Each terminal set includes inner and outer terminal members, which increase the contact area when busbar is inserted, thereby the terminal set can conduct a higher total current. The coordinated design of the insulating housing and the latch member allows the connector to be secured to the panel of an electronic device without the need for additional tools. Furthermore, the structural design between the terminal sets and the cable connection assemblies can be adjusted to accommodate different cable sizes and increased current requirements.

The foregoing description outlines features of various embodiments to enable those skilled in the art to better understand the aspects of the present disclosure. It will be understood by those skilled in the art that they may readily use the present disclosure as a basis for designing or modifying other processes and structures for achieving the same purposes and/or obtaining the same advantages as the embodiments described herein. Those skilled in the art will also recognize that such equivalent structures fall within the spirit and scope of the present disclosure, and that various changes, substitutions, and modifications can be made without departing from the spirit and scope of the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present invention cover modifications and variations of the disclosure provided they fall within the scope of the following claims.

What is claimed is:

1. A connector, comprising:
an insulating housing having two mounting slots;
two terminal sets respectively mounted in the two mounting slots, each of the two terminal sets comprising:
two outer terminal members each having an outer terminal connecting portion and a plurality of outer terminal spring arms, wherein a gap is formed between adjacent two of the outer terminal spring arms; and
two inner terminal members located between the two outer terminal members, each of the inner terminal members comprising an inner terminal connecting portion and a plurality of inner terminal spring arms, wherein a gap is formed between adjacent two of the inner terminal spring arms;
wherein the two outer terminal members are connected to each other through the outer terminal connecting portion and the two inner terminal members are connected to each other through the inner terminal connecting portion; and
two cable connection assemblies respectively connected to the two terminal sets, each of the two cable connection assemblies comprising two cable connecting elements which are L-shaped.

2. The connector of claim 1, wherein in an arrangement direction of the outer terminal spring arms, a ratio of a width of each of the outer terminal spring arms to a width of the gap formed between the adjacent two of the outer terminal spring arms is greater than 1, and in an arrangement direction of the inner terminal spring arms, a ratio of a width of each of the inner terminal spring arms to a width of the gap formed between the adjacent two of the inner terminal spring arms is also greater than 1.

3. The connector of claim 1, wherein the two terminal sets are respectively a first terminal set and a second terminal set, each of the first terminal set and the second terminal set comprises a notch, and an opening direction of the notch of the first terminal set is opposite to an opening direction of the notch of the second terminal set.

4. The connector of claim 3, wherein the two cable connection assemblies are respectively a first cable connection assembly and a second cable connection assembly, the first cable connection assembly is connected to the first terminal set and passes through the notch of the second terminal set to connect to a cable, and the second cable connection assembly is connected to the second terminal set and passes through the notch of the first terminal set to connect to another cable.

5. The connector of claim 1, wherein each of the two terminal sets further comprises two terminal connecting members, one of the two terminal connecting members is located between adjacent one of the two of the outer terminal members and one of the inner terminal members, another one of the two terminal connecting members is located between adjacent another one of the two of the outer terminal members and another one of the two of the inner terminal members, and the two cable connecting elements of one of the two cable connection assemblies are connected to one of the two terminal sets respectively through the two terminal connecting members.

6. The connector of claim 5, wherein one of the two outer terminal members and one of the two cable connecting elements are located on an identical side of one of the two terminal connecting members, and another one of the two outer terminal members and another one of the two cable connecting elements are located on an identical side of another one of the two terminal connecting members.

7. The connector of claim 1, wherein each of the two cable connecting elements comprises a fixing portion and an extension portion, the fixing portion is connected to one of the two terminal sets, and the extension portion extends from the fixing portion away from the one of the two terminal sets.

8. The connector of claim 7, wherein the two cable connecting elements are respectively a first cable connecting element and a second cable connecting element, the fixing portion of the first cable connecting element and the fixing portion of the second cable connecting element are respectively located on opposite sides of the one of the two terminal sets.

9. The connector of claim 7, wherein lengths of the extension portions of the two cable connecting elements are different.

10. The connector of claim 1, further comprising a latch member assembled on an outer side of the insulating housing and configured to slide relative to the insulating housing, wherein the latch member comprises a main body portion and two engaging portions respectively connected to opposite sides of the main body portion, the insulating housing comprises two openings corresponding to the two engaging portions, and the main body portion is configured to slide relative to the insulating housing to allow the two engaging portions to pass through or withdraw from the two openings.

11. The connector of claim 1, wherein each of the two cable connecting elements comprises a fixing portion and an extension portion, the two fixing portions of the two cable connecting elements connected to one of the two terminal sets are respectively connected opposite sides of the one of the two terminal sets, and distances between outer side surfaces of the two fixing portions and a central axis of the one of the two terminal sets are different.

12. The connector of claim 1, wherein each of the two cable connecting elements comprises a fixing portion, an extension portion, and an expansion portion, the fixing portion is configured to connect to one of the two terminal sets, the extension portion extends from the fixing portion away from the one of the two terminal sets and is configured to connect to a cable, and the expansion portion extends away from the extension portion.

13. A connector, comprising:
an insulating housing having two insertion slots and two side windows, the two side windows being located on opposite sides of the insulating housing;
two terminal sets respectively mounted in the two insertion slots; and
two cable connection assemblies respectively connected to the two terminal sets, each of the two cable connection assemblies comprising a first cable connecting element and a second cable connecting element which are L-shaped, the first cable connecting element extending toward one of the two side windows to connect to a cable, and the second cable connecting element extending toward the other one of the two side windows to connect to another cable.

14. The connector of claim 13, wherein the insulating housing further comprises a partition wall, a first side wall, and a second side wall, the first side wall and the second side wall are parallel to each other and together define the two side windows therebetween, and the partition wall is located between the two terminal sets.

15. The connector of claim 14, wherein a first passage is formed between the first side wall and the partition wall, a second passage is formed between the second side wall and the partition wall, and the first passage and the second passage are configured to allow the first cable connecting elements of the two cable connection assemblies to pass through respectively.

16. The connector of claim 13, wherein each of the first cable connecting element and the second cable connecting element has a fixing portion and an extension portion which are plate-shaped, the fixing portion is connected to one of the two terminal sets, and the extension portion extends from the fixing portion toward one of the two side windows.

17. The connector of claim 16, wherein the fixing portion of the first cable connecting element is connected to one side of the one of the two terminal sets, and the fixing portion of the second cable connecting element is connected to another side of the one of the two terminal sets.

18. The connector of claim 17, wherein a distance between an outer side surface of the fixing portion of the first cable connecting element and a central axis of the one of the two terminal sets is different from a distance between an outer side surface of the fixing portion of the second cable connecting element to the central axis of the one of the two terminal sets.

19. The connector of claim 16, wherein the extension portions of the first cable connecting element and the second cable connecting element of one of the two cable connection assemblies connected to one of the two terminal sets are located on an identical side, and the extension portions of the first cable connecting element and the second cable connecting element of another one of the two cable connection assemblies connected to another one of the two terminal sets are located on another side.

20. The connector of claim 13, wherein each of the two terminal sets comprises:
two outer terminal members each comprising an outer terminal connecting portion and a plurality of outer terminal spring arms, wherein a gap is formed between adjacent two of the outer terminal spring arms, in an arrangement direction of the outer terminal spring arms, a ratio of a width of each of the outer terminal spring arms to a width of the gap formed between the adjacent two of the outer terminal spring arms is greater than 1; and
two inner terminal members located between the two outer terminal members, each of the inner terminal members comprising an inner terminal connecting portion and a plurality of inner terminal spring arms, wherein a gap is formed between adjacent two of the inner terminal spring arms, and in an arrangement direction of the inner terminal spring arms, a ratio of a width of each of the inner terminal spring arms to a width of the gap formed between the adjacent two of the inner terminal spring arms is greater than 1.
